(19) United States
(12) Patent Application Publication
(10) Pub. No.: US 2026/0225522 A1
(43) Pub. Date: Aug. 6, 2026

(54) SYSTEM AND METHOD FOR DEPLOYING HAZARD STRUCTURES

(71) Applicant: Torc Robotics, Inc., Blacksburg, VA (US)

(72) Inventor: Randy Allen Blount, Troutville, VA (US)

(21) Appl. No.: 19/046,115

(22) Filed: Feb. 5, 2025

(51) Int. Cl. B60Q 7/00; E05F 15/70

(52) U.S. Cl. CPC B60Q 7/00; E05F 15/70; E05Y 2400/446; E05Y 2400/65; E05Y 2900/516

(57) ABSTRACT

A system for deploying hazard structures from a vehicle is provided. The system includes a housing including an interior space within the housing. The housing is coupled to the vehicle. The system includes one or more hazard structures disposed within the interior space of the housing. The system includes an interconnecting component coupling the one or more hazard structures to each other. The one or more hazard structures are configured to be deployed from the housing and onto a surface as the vehicle moves along the surface. The interconnecting component maintains the one or more hazard structures at a predetermined distance relative to a rear of the vehicle.

### TECHNICAL FIELD

The field of the disclosure relates to deploying hazard structures and, in particular, to a system for automatically deploying hazard structures behind a vehicle as the vehicle performs a safety maneuver.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

Typically, when an emergency occurs, the vehicle can perform a safety maneuver by slowing down and stopping on a shoulder of the road along which the vehicle was traveling. In some instances, the vehicle may need to stop on the road itself. According to certain industry standards, hazard structures (e.g., reflecting triangles, or the like) are required to be positioned on the shoulder and/or road behind the stopped vehicle to alert other drivers of the stopped vehicle. (See, e.g., Federal Motor Carrier Safety Administration (FMCSA) Regulation 392.22(b)). The industry standards generally require a specific spacing between the hazard structures relative to each other and the stopped vehicle. Positioning these hazard structures on the shoulder and/or road can be time consuming and dangerous, particularly during nighttime conditions. In addition, manual placement of the hazard structures can be inaccurate due to user error. For autonomous vehicles that perform the safety maneuver, due to a lack of a human driver, the hazard structures cannot be positioned on the shoulder and/or road until a service technician arrives to the scene, resulting in lack of alerting to other drivers for an extended period of time.

Accordingly, there exists a need for a system and a method of deploying hazard structures from a vehicle (autonomous, semi-autonomous and/or non-autonomous). These and other needs are met by the exemplary system for deploying hazard structures discussed herein.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, an exemplary system for deploying hazard structures from a vehicle is provided. The system includes a housing including an interior space within the housing. The housing is configured to be coupled to the vehicle. The system includes one or more hazard structures disposed within the interior space of the housing. The system includes an interconnecting component coupling the one or more hazard structures to each other. The one or more hazard structures are configured to be deployed from the housing and onto a surface as the vehicle moves along the surface. It should be understood that the hazard structures can be deployed onto any surface on which the vehicle can perform the safety maneuver and stop, such as a road, or the like. The interconnecting component maintains the one or more hazard structures at a predetermined distance relative to a rear of the vehicle.

In some embodiments, the vehicle can be, e.g., an autonomous vehicle, a semi-autonomous vehicle, a non-autonomous vehicle, or the like. T he housing can include a door configured to be actuated into an open position to deploy the one or more hazard structures from the housing and onto the surface . In some embodiments, the interior space of the housing can include a bottom surface with a flat section and a downwardly angled section near an outlet end of the housing. In some embodiments, the housing can include a flat bottom surface oriented at a non-parallel angle relative to horizontal to ensure downward and outward movement of the hazard structures during deployment at least partially via gravity. In particular, the downwardly angled section allows a gravitational force to act on the one or more hazard structures to deploy the one or more hazard structures from the housing.

In some embodiments, the system can include a retraction mechanism configured to be actuated to retract the one or more hazard structures and the interconnecting component into the interior space of the housing. In some embodiments, the one or more hazard structures can include a collapsible cone or triangle. The collapsible cone or triangle can include a weighted base. In some embodiments, a top point of the collapsible cone or triangle can include a light source configured to emit a continuous or blinking light.

The interconnecting component can couple the one or more hazard structures to the housing. In some embodiments, the interconnecting component can be a webbing material. The one or more hazard structures can include a first hazard structure, a second hazard structure, and a third hazard structure. The interconnecting component can include a first section coupling the first hazard structure to the housing, a second section coupling the second hazard structure to the first hazard structure, and a third section coupling the third hazard structure to the second hazard structure.

In such embodiments, a length of each of the first section, the second section and the third section of the interconnecting component can be selected based on industry standards, e.g., Department of Transportation (DOT) standards, or the like, for deploying emergency warning devices. In some embodiments, a length of the first section can be about 10 ft, a length of the second section can be about 100 ft, and a length of the third section can be about 100 ft, to maintain the first hazard structure at the predetermined distance relative to the rear of the vehicle.

In some embodiments, the first, second and third hazard structures can be configured to be consecutively deployed from the housing such that the first, second and third hazard structures are laterally offset relative to each other behind the rear of the vehicle. The system can include a processing device in communication with the housing. The processing device can be configured to execute instructions stored in a memory to actuate deployment of the one or more hazard structures from the housing and onto the surface upon receiving a signal indicative of a pull-over procedure being performed by the vehicle. The signal can be generated by one or more sensors associated with the vehicle and in communication with the processing device.

In another aspect, an exemplary computer-implemented method for deploying hazard structures from a vehicle is provided. The method includes receiving a signal from one or more sensors associated with the vehicle indicative of a pull-over procedure being performed by the vehicle. The method includes executing instructions stored in a memory with a processing device in communication with the one or more sensors to perform operations for deployment of hazard structures. The operations include deploying one or more hazard structures from a housing coupled to the vehicle and onto a surface as the vehicle moves along the surface . The housing includes an interior space within the housing. The one or more hazard structures are disposed within the interior space of the housing. An interconnecting component couples the one or more hazard structures to each other. The interconnecting component maintains the one or more hazard structure at a predetermined distance relative to a rear of the vehicle. The housing can include a door, and the operations can include actuating the door into an open position to deploy the one or more hazard structures from the housing.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic perspective view of an autonomous truck.

FIG. 2 is a schematic perspective view of an autonomous truck and trailer.

FIG. 3 is a schematic side view of an autonomous truck and trailer.

FIG. 4 is a block diagram of the autonomous truck shown in FIGS. 1-3.

FIG. 5 is a block diagram of an example computing system.

FIG. 6 is a block diagram of an exemplary system for deploying hazard structures.

FIG. 7 is a flowchart of a method for deploying hazard structures.

FIG. 8 is a top view of an exemplary system for deploying hazard structures in a deployed configuration.

FIG. 9 is a side view of an exemplary system for deploying hazard structures in a deployed configuration and including a crank for retraction.

FIG. 10 is a detailed view of a housing of an exemplary system for deploying hazard structures, disposed between the chassis of the vehicle.

FIG. 11 is a detailed view of a housing of an exemplary system for deploying hazard structures, including hazard structures in a retracted or stored configuration on a ramped surface.

FIG. 12 is a detailed view of a housing of an exemplary system for deploying hazard structures, including hazard structures in a retracted or stored configuration on an angled surface.

FIG. 13 is a detailed view of hazard structures of an exemplary system for deploying hazard structures, including hazard structures in a deployed configuration.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

The exemplary system for deploying hazard structures provides an automated means for deploying the hazard structures behind a vehicle during a safety maneuver, thereby replacing the traditionally manual task performed by the driver during an emergency stop. The system deploys the hazard structures in a manner that maintains the industry required distance between the hazard structures themselves, as well as the hazard structures and the vehicle. The system can be used in a variety of vehicles, including autonomous, semi-autonomous, and non-autonomous.

The system includes a housing capable of being affixed to the vehicle (e.g., the tractor of a tractor-trailer combination). In some embodiments, the housing can be fabricated from a metal and forms a box or enclosure capable of accommodating the hazard structures in a collapsed configuration. In some embodiments, the housing can angle downwardly towards the rear of the vehicle to at least partially rely on gravity for deploying the hazard structures. The housing can include a remotely activated latch to open a door of the housing, thereby allowing the hazard structures to deploy (with the assistance of gravity, in some embodiments).

The hazard structures can be in the form of three collapsible cones or triangles connected to each other by, e.g., a webbing or elongated material. The connecting material ensures that the desired distance is maintained between the hazard structures during/after deployment. For example, the first hazard structure to leave the housing can be exactly 100 ft from the second hazard structure, and the second hazard structure can be exactly 100 ft from the third hazard structure. The third hazard structure can be about 10 ft from the rear of the vehicle.

The hazard structures can be spread out from the vehicle and each other by the forward motion of the vehicle as it pulls over on the shoulder of the road, for example, or as it generally slows down during the emergency safety maneuver. In some embodiments, each hazard structure can include a built-in flashing light emitting diode (LED) which can be battery or solar operated and can be activated by the “popping-up” action of the hazard structure once it is deployed from the housing. In some embodiments, each hazard structure can include reflective material (e.g., reflective tape) that ensures reflectivity during passage of other vehicles. In some embodiments, the reflective material can cover the entire outer surface of the side walls of the hazard structure to maximize reflectivity.

In some embodiments, each hazard structure can include a spring-like structure that allows the hazard structure to be compressed into a flatter configuration for storage in the housing, and – upon deployment – allows for the hazard structure to pop-up or spring-up into a fully deployed configuration. For example, the spring-like structure can be in the form of a tapered coil leading from the base to the top of the hazard structure. In some embodiments, the base of the hazard structure can include a weight or sand-filled structure that ensures the proper orientation of the hazard structure upon deployment. In some embodiments, the bottom surface of the base can include a rubber, slick or friction resistant coating or structure to allow for dragging along the road behind the vehicle during deployment minimal wear.

The system can include a retraction mechanism, e.g., a crank, or the like, capable of being actuated to retract the hazard structures and the connecting material into the housing after use. The retraction operation can be performed manually or in an automated manner. For example, mission control can activate the retraction mechanism remotely to gather the hazard structures into the housing before initiating further operation/travel of the vehicle. The system can include one or more sensors associated with the housing to confirm that all hazard structures have been successfully retracted into the housing.

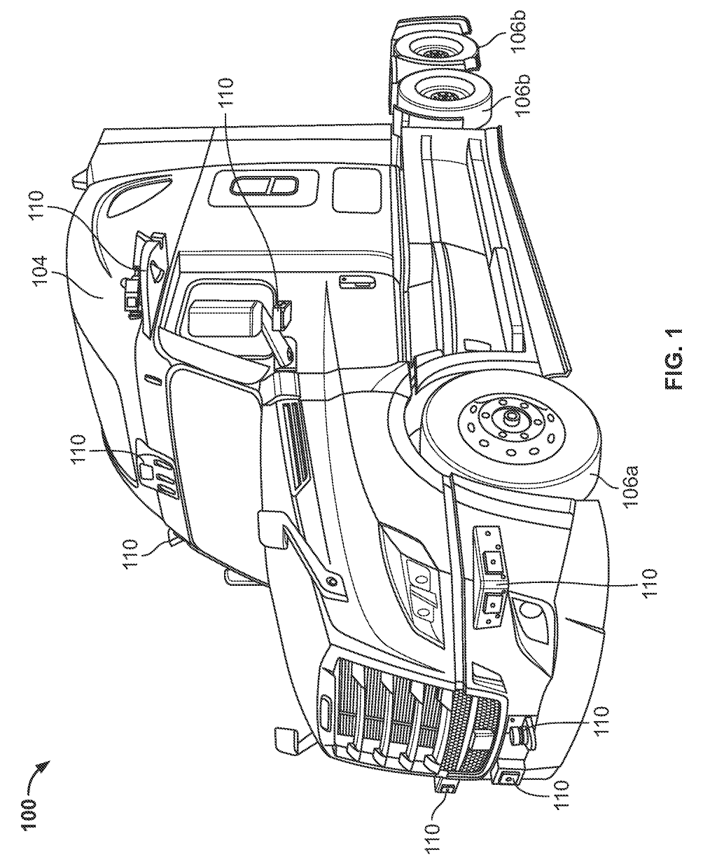

Various embodiments in the present disclosure are described with reference to FIGS. 1-13 below.

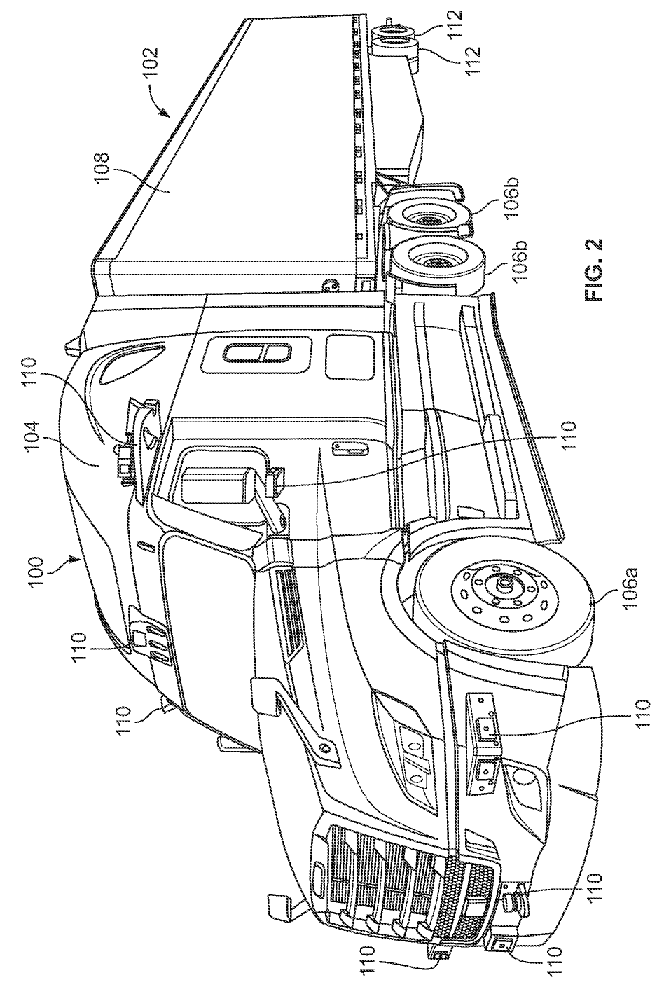

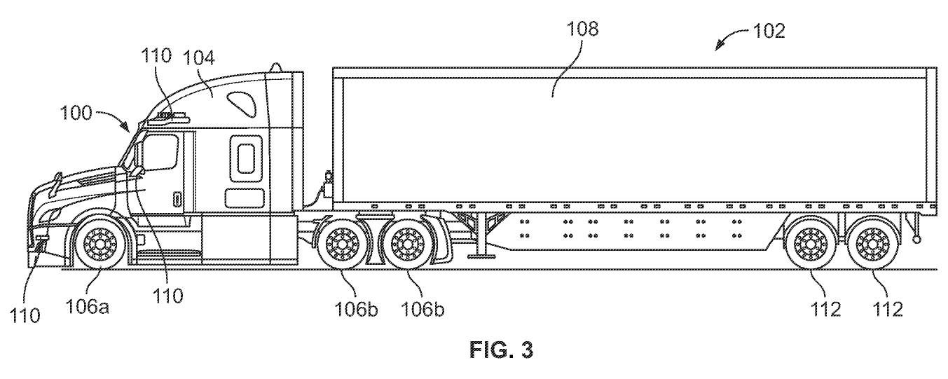

FIG. 1 is a perspective view of a vehicle 100, such as a truck that may be conventionally connected to a single or tandem trailer 102 to transport the trailer 102 to a desired location, as shown in FIGS. 2 and 3, which are, respectively, perspective and side views of the vehicle 100 of FIG. 1 with the trailer 102 attached thereto. The vehicle 100 includes a cabin 104 that can be supported, and steered in the required direction, by front wheels 106a and rear wheels 106b that are partially shown in FIG. 1. The front wheels 106a are positioned by a steering system that includes a steering wheel and a steering column (not shown). The steering wheel and the steering column may be located in the interior of cabin 104.

The vehicle 100 may be an autonomous vehicle, in which case the vehicle 100 may omit the steering wheel and the steering column to steer the vehicle 100. Rather, the vehicle 100 may be operated by an autonomy computing system of the vehicle 100 based on data collected by a sensor network including one or more sensors, e.g., sensors 110 shown in FIGS. 1-3. The vehicle 100 may additionally include a fifth-wheel coupling (not shown) to which the trailer 102 can be releasably attached. The trailer 102 can include a storage container 108 and a plurality of rear wheels 112 that support the storage container 108. It should be understood that in some embodiments the vehicle 100 and the trailer 102 can be a permanently attached as a single unit.

The sensors 110 have a field-of-view at the front, sides and/or rear of the vehicle 100. Similar sensors 110 can be used around the perimeter of the vehicle 100 to ensure full environmental coverage around the vehicle 100 is provided by the sensors 110. In some embodiments, the vehicle 100 can include, e.g., 5-6 LIDAR sensors, 8-10 cameras, combinations thereof, or the like. In some embodiments, the vehicle 100 can tow a trailer 102 and the trailer 102 can similarly include LIDAR sensors and/or cameras to provide field-of-view coverage around the perimeter of the vehicle 100 and the trailer 102. The environmental coverage by the sensors and/or cameras therefore provides data corresponding with the front, rear, sides and corners of the vehicle 100 and the trailer 102 hauled by the vehicle 100.

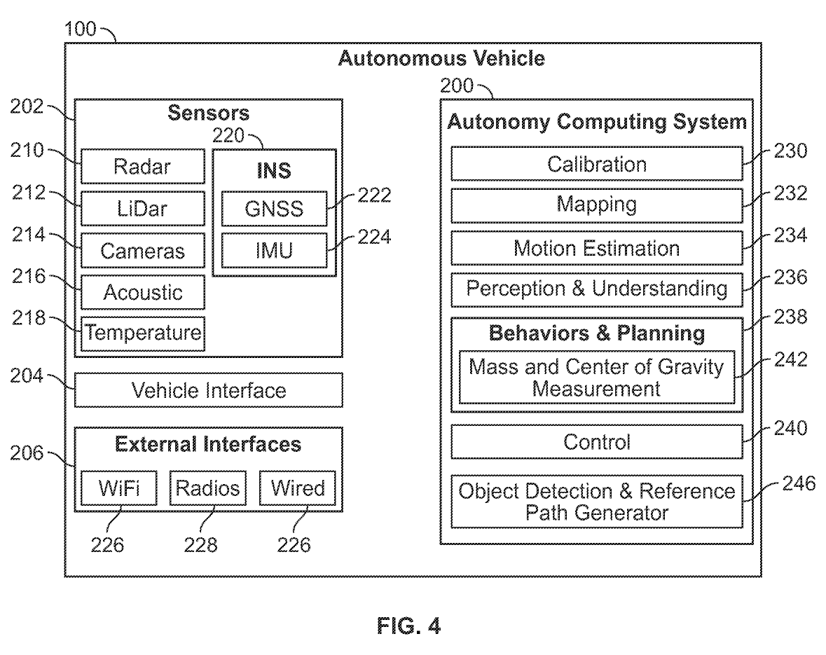

FIG. 4 is a block diagram representing autonomous vehicle 100 shown in FIGS. 1-3. In the example embodiment, autonomous vehicle 100 generally includes autonomy computing system 200, sensors 202, a vehicle interface 204, and external interfaces 206. It should be understood that the sensors 110 on the vehicle 100 in FIGS. 1-3 and described herein correspond to the sensors identified as 202 in FIG. 4. The sensors 110 may specifically comprise any of the sensors 210-220 shown in FIG. 4 and described herein.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying objects around the vehicle 100, updating a reference path based on the detected objects, and controlling operation of the vehicle 100 to guide the vehicle 100 along its route.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100. In some embodiments, the trailer associated with the vehicle 100 can include similar sensors 202 for gathering similar data associated with the trailer, thereby further assisting with control operations of the autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 226, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a mass and center of gravity measurement module 242, a control module or controller 240, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

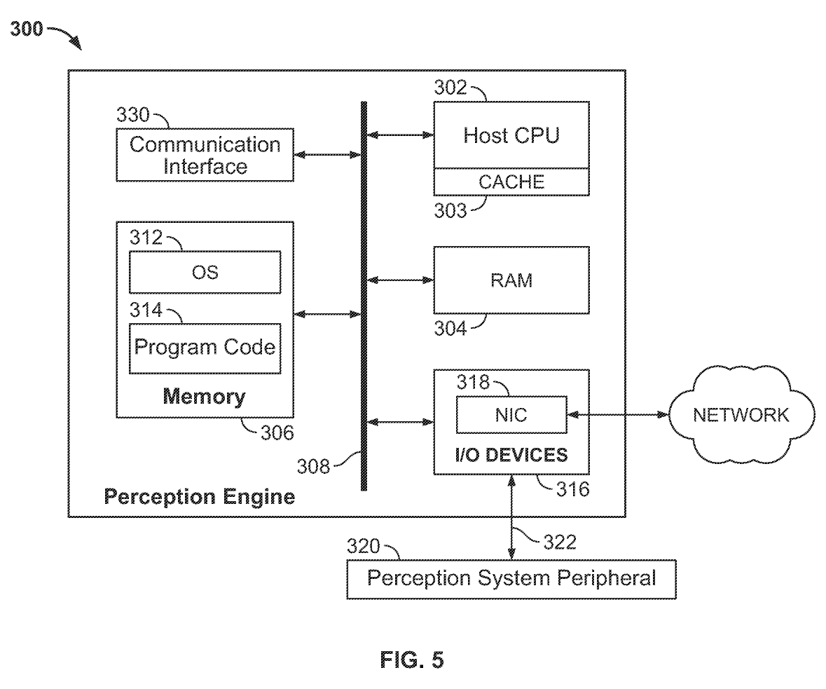

FIG. 5 is a block diagram of an example computing system 300, such as the autonomy computing system 200 shown in FIG. 4, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 4. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

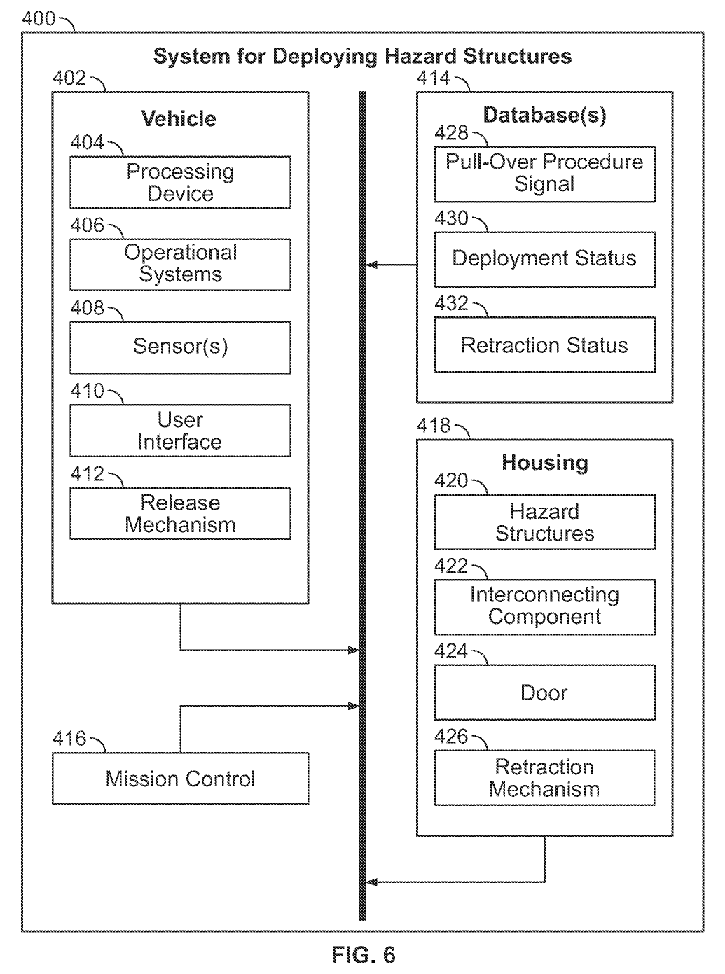

FIG. 6 is a block diagram of an exemplary system 400 for deploying hazard structures from a vehicle. The system 400 generally includes one or more vehicles 402 (e.g., autonomous vehicle 100, semi-autonomous vehicle, and/or non-autonomous vehicle). The vehicle 402 includes a processing device 404 (e.g., computing system 200, computing system 300, or the like) configured to receive and process data for deploying and/or retracting the hazard structures from the vehicle 402. The vehicle 402 can include one or more operational systems 406 (e.g., mapping 232, motion estimation 234, perception and understanding 236, behaviors and planning 242, control 240, object detection and reference path generator 246, combinations thereof, or the like) for operating the vehicle 402 within an environment.

The vehicle 402 can include one or more sensors 408 (e.g., sensors 202) for detecting the environment and objects within the environment around the vehicle 402. For example, the sensors 202 can assist the vehicle 402 in detecting the shoulder of a road when the vehicle 402 is performing the safety maneuver, as well as objects on the shoulder, ensuring that the safety maneuver is performed by the vehicle 402 without collisions or complications. As a further example, the sensors 202 can detect when the vehicle 402 is crossing a lane/shoulder divider line to initiate deployment of the hazard structures from the vehicle 402, although different lane markers can be used to initiate the deployment.

In some embodiments, the sensors 202 can detect when the vehicle 402 is fully on the shoulder prior to deployment of the hazard structures to ensure that the hazard structures do not occupy any portion of the lanes of travel of the roadway, thereby avoiding interference with other vehicles on the roadway. Deployment of the hazard structures can therefore be delayed until the truck is fully off of the roadway, e.g., fully on the shoulder. If the vehicle 402 is unable to pull over onto a shoulder or must stop in the lane of travel for some reason, the hazard structures can be deployed on the roadway itself. In all instances where the vehicle 402 is programmed to stop and remain in the roadway or on the shoulder, the hazard structures can be deployed as soon as the distance necessary for safe deployment is achieved, e.g., no less than 220 feet from the rearmost portion of the vehicle 402 to ensure the hazard structures and their interconnecting components can be fully deployed and positioned behind the vehicle 402 prior to stopping of the vehicle 402.

The vehicle 402 includes a user interface 410 (e.g., vehicle interface 204) configured to receive/transmit and display data for operation of the system 400, as well as the vehicle 402 itself. In some embodiments, the vehicle 402 can include a separate release mechanism 412 for deploying the hazard structures from the vehicle 402. For example, the release mechanism 412 can be in the form of a button or lever configured to be manually actuated to release the hazard structures. In some embodiments, the release mechanism 412 can be incorporated into the user interface 410, such that an electronic button can be actuated to release the hazard structures. In some embodiments, the release mechanism 412 can be programmed into the operational systems 406 of the vehicle 402 such that the hazard actuators can be automatically deployed by the vehicle 402 when the safety maneuver is being performed. The hazard structures can be deployed on any surface, such as a road, along which the vehicle 402 can travel and stop for the safety maneuver. In some embodiments, the system 400 can be triggered to deploy the hazard structures from the vehicle 402 by communication of the vehicle 402 (e.g., via an autonomous driving system or processing device) with the release mechanism 412 that secures the door for the enclosure in which the hazard structures are contained. The communication can indicate that the vehicle 402 must move onto the shoulder of the roadway or must perform a maneuver in which the vehicle 402 is to stop in the lane of travel for safety or emergency purposes, e.g., a minimal risk maneuver (MRM).

The vehicle 402 can include one or more databases 414 (e.g., memory 306) configured to receive and electronically store data. In some embodiments, the database 414 can be stored externally from the vehicle 402 and the vehicle 402 can be in communication with the external database 414 for receiving and/or transmitting data associated with the system 400. In some embodiments, the database 414 can be stored at mission control 416 external to the vehicle 402 and in communication with the vehicle 402. In some embodiments, the database 414 can be located on the vehicle 402 itself. In some embodiments, one or more portions of the database 414 can be distributed across components of the system 400. The database 414 can store information relating to deploying and retraction of the hazard structures from the vehicle 402.

The system 400 includes at least one housing 418 configured to enclose multiple hazard structures 420 to be deployed from the housing 418 upon actuation of the release mechanism 412. Although discussed herein as including three hazard structures 420, it should be understood that any number of hazard structures 420 could be used with the system 400. In some embodiments, the housing 418 can be fabricated from a metal (e.g., aluminum, titanium, or the like) to ensure safety to the interior components, and can be mounted between the chassis and/or wheels of the vehicle 402. In some embodiments, the housing 418 can be mounted below the vehicle 402 such that deployment of the hazard structures 420 occurs under the vehicle 402.

In some embodiments, the hazard structures 420 can be in the form of collapsible triangles or cones that are stored in their collapsed configuration within the housing 418 prior to deployment. For example, a tapered, helical coil or wire of spring-like material can be used to collapse or compress the hazard structures 420 for storage, while allowing for automatic popping up or expansion of the hazard structures 420 upon deployment. In the collapsed configuration, the hazard structures 420 can be substantially flat. In the expanded configuration, the hazard structures 420 can be substantially triangular or conical.

The hazard structures 420 can be fabricated from a material having an orange or bright color for visibility on the road. Each hazard structure 420 can include reflective material, e.g., tape, covering at least a portion of the side wall. In some embodiments, the reflective material can cover the entire side wall(s) of the hazard structure 420. The reflective material provides for increased visibility of the hazard structures 420 by other vehicles. In some embodiments, each hazard structure 420 can include a light emitting diode (LED) at the uppermost point and connected to a power source, e.g., a rechargeable battery. The LED can be configured to illuminate continuously or at a predetermined frequency (e.g., a beacon) to provide additional visibility of the hazard structures 420. The LED can be configured to illuminate only upon deployment of the hazard structures 420.

Each hazard structure 420 includes a base connected to the side wall(s). The base can include a weighted material, e.g., sand, or the like, to provide a greater weight on the bottom of the hazard structure 420. The weighted material results in the proper orientation of the hazard structure 420 upon deployment from the housing 418. The bottom surface of the base can be fabricated from or includes a coating having friction resistant properties, e.g., hard rubber, or the like. Such friction resistant properties allow the hazard structure 420 to be dragged along the road behind the vehicle 402 after deployment with minimal (or no) wear.

The hazard structures 420 can be connected to each other and the housing 418 by interconnecting components 422. The interconnecting component 422 can be in the form of a webbing, tape, rope, a mesh, combinations thereof, or the like. The interconnecting components 422 can be formed from a durable material resistant to friction and/or wear, since the components 422 will also drag along the road after deployment from the vehicle 402. The interconnecting components 422 provide a predetermined length between the hazard structures 420 to ensure industry standards for deployment of the hazard structures 420 are meet. For example, the distance between the first hazard structure 420 to be deployed and the second hazard structure 420 to be deployed can be about 100 ft. Similarly, the distance between the second and third hazard structures 420 deployed from the vehicle 402 can be about 100 ft. The distance between the third hazard structure 420 and the rear edge of the vehicle 402 can be about 10 ft.

It should be understood that these distances can be adjusted depending on the industry requirements in the region of use. In some embodiments, the system 400 can receive as input the vehicle 402 dimensions and, based on these dimensions, can determine the length of the interconnecting component 422 to release from the housing 418. For example, if the vehicle 402 is a single trailer truck, the interconnecting component 422 between the last hazard structure 420 to be deployed can be different (i.e., shorter) than if the vehicle 402 is a double trailer truck. For example, a controller associated with the mechanism for deploying the hazard structures 420 (e.g., the retraction mechanism 426 which doubles as both the deployment and retraction mechanism with a signal from the release mechanism 412) can determine the length of the interconnecting component 422 to release based on the input vehicle 402 information.

In some embodiments, the system 400 can include a dedicated power source associated with the latch of the door 424 and configured to automatically actuate unlatching/opening of the door 424 upon detection that all electrical systems for the vehicle 400 are non-operational and an emergency maneuver is needed to stop the vehicle 402 on the side of the road. In some embodiments, unlatching of the door 424 can be performed remotely through, e.g., a signal from mission control 416, or the like. In some embodiments, the hazard structures 420 can be automatically released upon detection that the vehicle 402 is moving onto a shoulder of the road and slowing down. In some embodiments, if a complete power failure of the vehicle 402 occurs, a dedicated power source and communication module can be used to support the functions of receiving a signal and executing the actions to ensure either an automatic deployment (e.g., following a minimal risk maneuver) or a remotely triggered deployment of the hazard structures by mission control 416.

In some embodiments, the bottom surface or floor of the housing 418 can be substantially flat, e.g., parallel to horizontal. In some embodiments, one or more portions of the bottom surface or floor of the housing 418 can be downwardly angled towards the road to at least partially rely on gravity assistance for deploying of the hazard structures 420 from the housing 418. In some embodiments, the housing 418 can include a mechanism for deploying the first hazard structure 420, and contact/friction of the first hazard structure 420 with the road surface can deploy the remaining hazard structures 420. In some embodiments, gravity can be used to assist with deployment of the first hazard structure 420, with contact/friction of the first hazard structure 420 with the road surface deploying the remaining hazard structures 420 from the housing 418. The housing 418 can include a door 424 hingedly coupled to the housing 418. The door 424 can be selectively actuated to open and close with the release mechanism 412 of the vehicle 402 to deploy the hazard structures 420 while the vehicle 402 is moving.

In some embodiments, the hazard structures 420 can be released substantially in-line with each other (e.g., with no lateral offset). In some embodiments, the housing 418 can include a bottom surface configured to be selectively opened to laterally offset the hazard structures 420 deployed from the housing 418. In such embodiments, the housing 418 can extend laterally across the catwalk/cab frame with progressively opening doors 424 for releasing the hazard materials 420 on the right, middle and left side of the housing 418. For example, the first hazard structure 420 can be deployed laterally to the right relative to the second hazard structure 420, and the third hazard structure 420 can be deployed laterally to the left of the second hazard structure 420, thereby positioning the hazard structures both laterally and longitudinally offset relative to each other. In such embodiments, the interconnecting component 422 can be structured to maintain both the lateral and longitudinal offset of the hazard structures 420.

The system 400 can include a retraction mechanism 426 disposed at least partially within the housing 418 for retracting the hazard structures 420 back into the housing 418 after use. In some embodiments, the retraction mechanism 426 can include a hand crank associated therewith for manual winding and retraction of the hazard structures 420 and the interconnecting components 422. In some embodiments, the retraction mechanism 426 can be connected to a motor configured to wind the hazard structures 420 and the interconnecting components 422. In some embodiments, the retraction mechanism 426 can be operated automatically and remotely from the vehicle 402, e.g., by using the user interface 410. During retraction, the hazard structures 420 and the interconnecting components 422 can be gradually brought back inside of the housing 418, with the hazard structures 420 in the collapsed configuration until further use. Once fully within the housing 418, the door 424 can be closed and latched into the locking position.

The release mechanism 412 can ensure that the hazard structures 420 remain upright and the interconnecting components 422 that attach the hazard structures 420 to each other remain untangled when deployed. This can be achieved by ensuring that the base of the hazard structures 420 is broad enough and weighted to a degree that would ensure that the bottom of the hazard structures 420 remains in contact with the road surface during and after its deployment. The retraction mechanism 426 can be, in some embodiments, a motorized crank associated with the enclosure for the hazard structures 420. The retraction mechanism 426 allows for retraction of the hazard structures 420 into the enclosure. The motorized crank can include a crank handle that can be detachable and stored in the vehicle 402, and could be used to manually crank the hazard devices 420 back into the enclosure in which the hazard devices 420 were previously stored in prior to deployment. As the hazard devices 420 are brought into the restricted opening of the enclosure, the restriction can apply a force to the hazard structures 420 that collapses the hazard structures 420 for storage. In some embodiments, the restriction process for entry into the enclosure can be achieved with, e.g., hook and loop strips, magnets, or the like, added to the upper and lower interior areas of the hazard structures 420. The strength of the hook and loop and/or magnetic bond can be such that the hazard structures 420 remain collapsed during retraction, but also open during their deployment.

The database 414 can store data associated with operation of the system 400. For example, the database 414 can store information relating to pull-over procedure signals 428. The signals 428 can be indicative of the safety maneuvers performed by the vehicle 402, and can be in the form of an alert transmitted to mission control 416 to notify a central location of the safety maneuver being performed. In some embodiments, the signals 428 can serve as a log of safety maneuvers performed by the vehicle 402.

The database 414 can include the deployment status 430 and/or the retraction status 432 relating to the housing 418 and the hazard structure 420 deployment/retraction. For example, the deployment status 430 can indicate when all hazard structures 420 have been deployed, indicating to the vehicle 402 (and/or an operator of the vehicle 402) when the vehicle 402 can fully stop. In some embodiments, the sensors 408 associated with the vehicle 402 can detect deployment of the hazard structures 420, indicating that proper position of the hazard structures 420 has been reached, allowing the vehicle 402 to stop. The retraction status 432 can indicate when all hazard structures 420 have been retracting into the housing 418 with the door 424 closed, allowing the vehicle 402 to continue movement along its intended path. In some embodiments, the retraction status 432 can include a confirmation that the hazard structures 420 were properly deployed and their position can be estimated using, e.g., rearward facing sensors 408 (such as radar and/or cameras). The proper retraction of the hazard structures 420 could be confirmed with a signal transmitted from the retraction mechanism 426 that secures the housing door 424 to the processing device 404 and/or mission control 416.

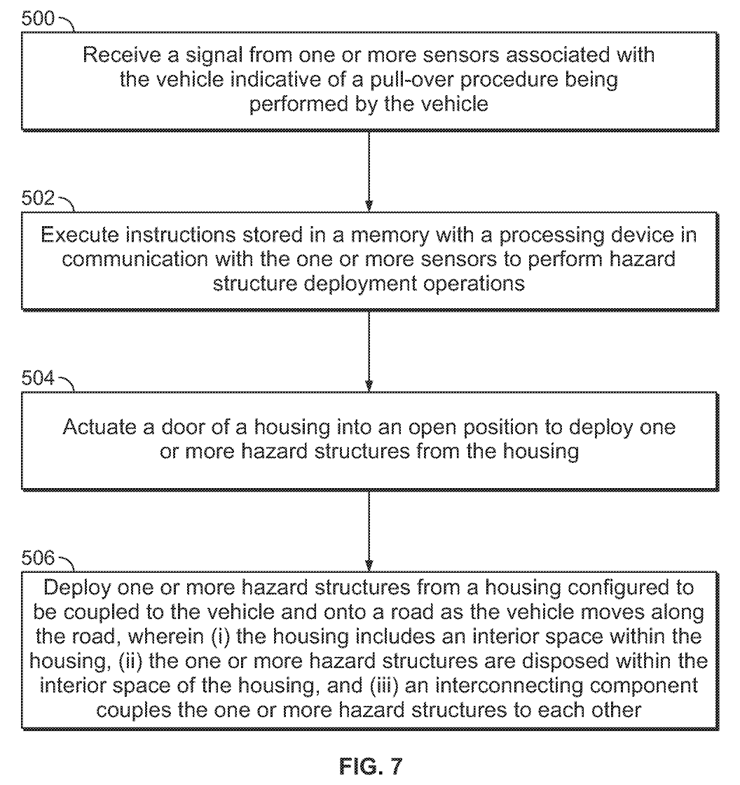

FIG. 7 is a flowchart of a method of deploying hazard structures by the exemplary system 400 discussed herein. At 500, a signal is received from one or more sensors associated with the vehicle indicative of a pull-over procedure being performed by the vehicle. At 502, instructions stored in a memory are executed with a processing device in communication with the one or more sensors to perform hazard structure deployment operations. At 504, a door of a housing is actuated into an open position to deploy one or more hazard structures from the housing. At 506, one or more hazard structures are deployed from the housing configured to be coupled to the vehicle and onto a road as the vehicle moves along the road. The housing includes an interior space within the housing. The one or more hazard structures are disposed within the interior space of the housing. An interconnecting component couples the one or more hazard structures to each other and to the vehicle.

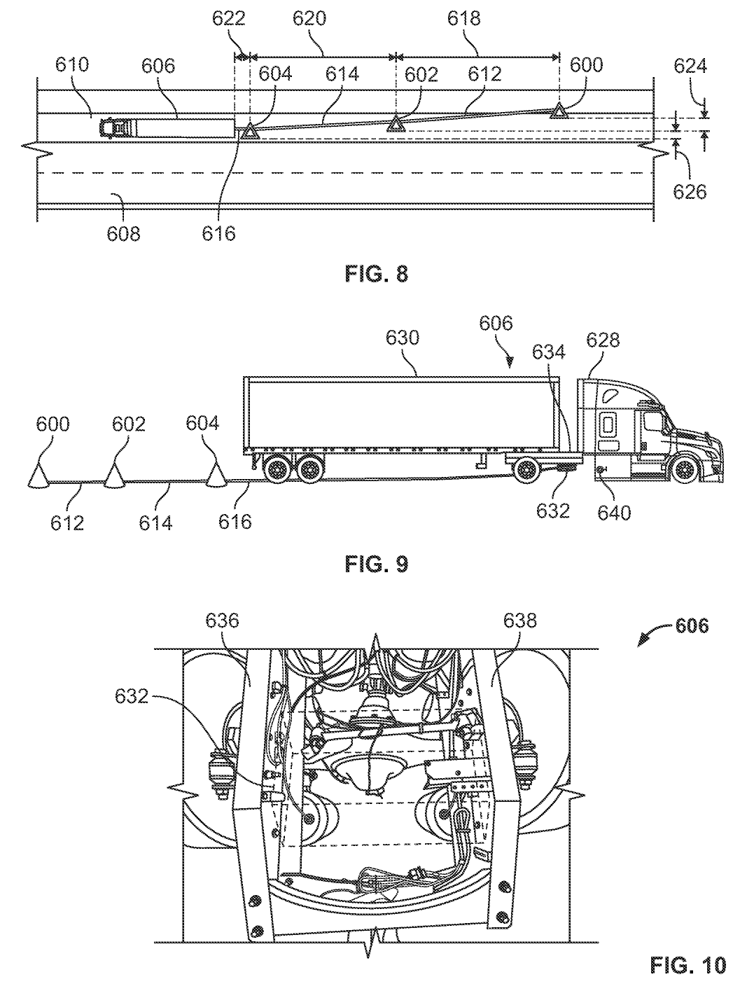

FIG. 8 is a top view illustrating operation of the system 400, particularly the deployment of hazard structures 600, 602, 604 from the vehicle 606. As the vehicle 606 is traveling along the road 608, an emergency safety maneuver may need to be performed, necessitating that the vehicle 606 stop on the shoulder 610 (if one is available). The system 400 initially deploys the first hazard structure 600, with contact of the structure 600 with the road 608 and/or shoulder 610 assisting with deployment of subsequent hazard structures 602, 604 due to the interconnecting components 612, 614, 616. In particular, the interconnecting component 612 connects the hazard structures 600, 602, the interconnecting component 614 connects the hazard structures 602, 604, and the interconnecting component 616 connects the hazard structure 604 to the vehicle 606 (and/or the housing from which the hazard structures 600, 602, 604 are deployed).

The interconnecting components 612, 614, 616 maintain the predetermined distance between the respective hazard structures 600, 602, 604 and the vehicle 606. The distance 618 between the hazard structures 600, 602 can be about 100 ft, the distance 620 between the hazard structures 602, 604 can be about 100 ft, and the distance 622 between the hazard structure 604 and the rear edge of the vehicle 606 can be about 10 ft. These distances 618, 620, 622 can represent the longitudinal distance, i.e., the distance behind the vehicle 606 taken in a substantially linear manner. In some embodiments, the hazard structures 600, 602, 604 can be substantially in-line with each other. In some embodiments, the hazard structures 600, 602, 604 can be deployed such that a lateral offset distance 624, 626 exists between the respective hazard structures 600, 602, 604.

FIG. 9 is a side view of the vehicle 606 (of FIG. 8) after deployment of the hazard structures 600, 602, 604. The vehicle 606 includes a truck 628 and a trailer 630. The housing 632 for that receives the hazard structures 600, 602, 604 in their stored or retracted state can be coupled to the chassis 634 of the vehicle 606. For example, FIG. 10 is a detailed view of the housing 632 mounted between opposing chassis members 636, 638. The mounting position of the housing 632 allows for the hazard structures 600, 602, 604 to be deployed between the wheels of the vehicle 606, thereby avoiding contact between the wheels and the hazard structures 600, 602, 604. A deployment/retraction mechanism 640 can be provided within the truck 628 and/or external to the truck 628 for selective deployment and retraction of the hazard structures 600, 602, 604 (FIG. 9).

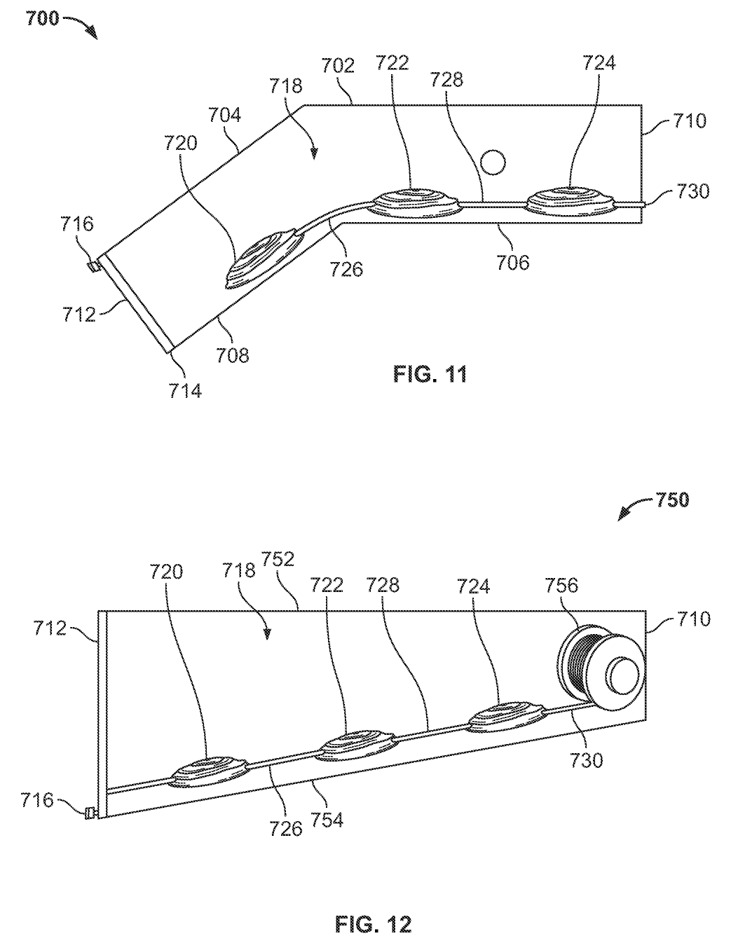

FIG. 11 is a detailed view of a housing 700 configured to be used with the exemplary system for hazard structure deployment discussed herein. The housing 700 includes a top wall with a planar section 702 and a downwardly angled section 704, and an opposing bottom wall with a planar section 706 and a downwardly angled section 708 that substantially match and extend parallel to the sections 702, 704. The housing 700 includes a rear, fixed wall 710, and a door 712 hingedly coupled to the edges of the opposing end of the housing 700. In particular, the housing 700 can include a hinge 714 coupling one edge of the door 712 to the bottom wall (or the top wall), and a latching mechanism 716 can be used to selectively lock the door 712 position relative to the top wall (or the bottom wall).

The housing 700 generally defines an interior 718 configured to receive the hazard structures 720, 722, 724, as well as the interconnecting components 726, 728, 730. In some embodiments, the interconnecting component 730 can secure the hazard structure 724 to the interior of the rear wall 710 of the housing 700. The hazard structures 720, 722, 724 can be in the compressed or collapsed configuration until deployment from the housing 700 occurs. In particular, when the door 712 is actuated to open and expose the opening at the end of the housing 700 at the angled sections 704, 708, the angled configuration at least partially relies on gravity to help with deployment of the hazard structure 720 from the housing 700. Once the first hazard structure 720 has been deployed, the other hazard structures 720 can follow based on the interconnecting component 726, 728.

FIG. 12 is a detailed view of a housing 750 configured to be used with the exemplary system for hazard structure deployment. The housing 750 can be substantially similar in structure and function, except for the distinctions noted herein. Thus, same reference numbers refer to the same structures. Rather than having independent angled and planar sections of the top and bottom walls, the top wall 752 can be planar (e.g., parallel to horizontal), while the entire bottom wall 754 can be angled downwardly (e.g., relative to horizontal and the road) to at least partially rely on gravity assisted deployment of the hazard structures 720, 722, 724. The housing 750 can include a mechanism 756 disposed at or near the rear wall 710. The mechanism 756 can be actuated to initiate and perform the deployment process, as well as the retraction process, of the hazard structures 720, 722, 724 from the interior 718 of the housing 750.

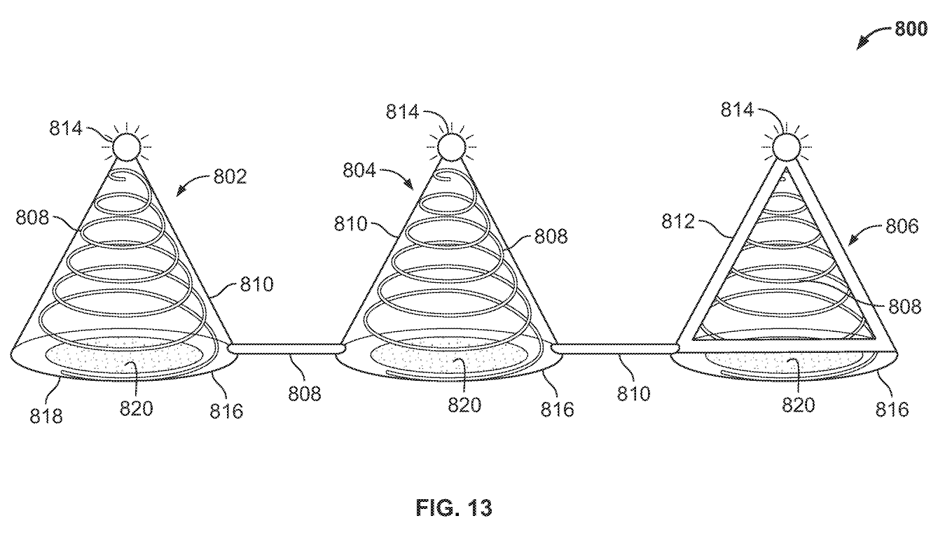

FIG. 13 is a detailed view of an exemplary system 800 for hazard structure deployment in the deployed configuration. As discussed herein, the system 800 deploys hazard structures 802, 804, 806 from a housing, with the hazard structures 802, 804, 806 connected to each other and/or the vehicle/housing by interconnecting components 808, 810. The interconnecting component coupling the hazard structure 806 to the vehicle/housing is not shown. Each hazard structure 802, 804, 806 can define a collapsible structure provided by an interior coil 808 which can be pressed into a substantially flat configuration. The coil 808 can be surrounded by an external structure 810, e.g., a flexible material, or the like, that defines a substantially conical configuration when the coil 810 is expanded (as shown in FIG. 13).

In some embodiments, the external structure 810 can include reflective material 812 attached thereto, or coating the external structure 810. In some embodiments, the reflective material 812 can be in the form of adhesive strips with a reflective surface to assist with visibility of the hazard structures 802, 804, 806 after deployment. In some embodiments, the hazard structures 802, 804, 806 can include a light 814 at the uppermost point or tip of the external structure 810. The light 814 can be connected to a power source, e.g., a battery, or the like, such that the light 814 can flash to further assist with visibility of the hazard structures 802, 804, 806 after deployment.

The hazard structures 802, 804, 806 each include a base 816 defining a bottom surface 818 configured to be in contact with the road after deployment. The bottom surface 818 (or the entire base 816) can be fabricated from a wear resistant material, e.g., a hard rubber, or the like, such that minimal wear or damage is incurred when the hazard structures 802, 804, 806 drag along the road surface. The base 816 can include a compartment configured to receive weighted material 820, e.g., sand, or the like, to provide greater weight to the base 816 (as compared to the upper portion of the hazard structures 802, 804, 806). The weighted base 816 ensures that the hazard structures 802, 804, 806 remain in the upright orientation when deployed from the housing. The system 800 therefore provides an automated means for deploying hazard structures 802, 804, 806 from a vehicle during a safety maneuver.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for deploying hazard structures from a vehicle, the system comprising:
a housing including an interior space within the housing, wherein the housing is configured to be coupled to the vehicle;
one or more hazard structures disposed within the interior space of the housing; and
an interconnecting component coupling the one or more hazard structures to each other;
wherein the one or more hazard structures are configured to be deployed from the housing and onto a surface as the vehicle moves along the surface; and
wherein the interconnecting component maintains the one or more hazard structures at a predetermined distance relative to a rear of the vehicle.

2. The system of claim 1, wherein the vehicle is an autonomous vehicle, a semi-autonomous vehicle, or a non-autonomous vehicle.

3. The system of claim 1, wherein the housing includes a door configured to be actuated into an open position to deploy the one or more hazard structures from the housing and onto the surface.

4. The system of claim 1, wherein the interior space of the housing includes a bottom surface with a flat section and a downwardly angled section near an outlet end of the housing.

5. The system of claim 4, wherein the downwardly angled section allows a gravitational force to act on the one or more hazard structures to deploy the one or more hazard structures from the housing.

6. The system of claim 1, comprising a retraction mechanism configured to be actuated to retract the one or more hazard structures and the interconnecting component into the interior space of the housing.

7. The system of claim 1, wherein the one or more hazard structures include a collapsible cone or triangle.

8. The system of claim 7, wherein the collapsible cone or triangle includes a weighted base.

9. The system of claim 7, wherein a top point of the collapsible cone or triangle includes a light source configured to emit a continuous or blinking light.

10. The system of claim 1, wherein the interconnecting component couples the one or more hazard structures to the housing.

11. The system of claim 1, wherein the interconnecting component is a webbing material.

12. The system of claim 1, wherein the one or more hazard structures include a first hazard structure, a second hazard structure, and a third hazard structure.

13. The system of claim 12, wherein the interconnecting component includes a first section coupling the first hazard structure to the housing, a second section coupling the second hazard structure to the first hazard structure, and a third section coupling the third hazard structure to the second hazard structure.

14. The system of claim 13, wherein a length of each of the first section, the second section and the third section of the interconnecting component is selected based on Department of Transportation (DOT) standards for deploying emergency warning devices.

15. The system of claim 13, wherein a length of the first section is 10 ft a length of the second section is 100 ft and a length of the third section is 100 ft to maintain the first hazard structure at the predetermined distance relative to the rear of the vehicle.

16. The system of claim 12, wherein the first, second and third hazard structures are configured to be consecutively deployed from the housing such that the first, second and third hazard structures are laterally offset relative to each other behind the rear of the vehicle.

17. The system of claim 1, comprising a processing device in communication with the housing, wherein the processing device is configured to execute instructions stored in a memory to actuate deployment of the one or more hazard structures from the housing and onto the surface upon receiving a signal indicative of a pull-over procedure being performed by the vehicle.

18. The system of claim 17, wherein the signal is generated by one or more sensors associated with the vehicle and in communication with the processing device.

19. A computer-implemented method for deploying hazard structures from a vehicle, the computer-implemented method comprising:
receiving a signal from one or more sensors associated with the vehicle indicative of a pull-over procedure being performed by the vehicle; and
executing instructions stored in a memory with a processing device in communication with the one or more sensors to perform operations comprising:
deploying one or more hazard structures from a housing configured to be coupled to the vehicle and onto a surface as the vehicle moves along the surface, wherein (i) the housing includes an interior space within the housing, (ii) the one or more hazard structures are disposed within the interior space of the housing, and (iii) an interconnecting component couples the one or more hazard structures to each other;
wherein the interconnecting component maintains the one or more hazard structure at a predetermined distance relative to a rear of the vehicle.

20. The method of claim 19, wherein the housing includes a door, and wherein the operations comprise actuating the door into an open position to deploy the one or more hazard structures from the housing.
